(19) United States
(12) Patent Application Publication
(10) Pub. No.: US 2006/0106661 A1
(43) Pub. Date: May 18, 2006

(54) Methods and apparatus for project schedule estimation

(75) Inventors: Robert Oikawa, Redmond, WA (US); William Reid, Seattle, WA (US); Mark Short, Redmond, WA (US)

Correspondence Address: Randy J. Pritzker;Wolf, Greenfield & Sacks, P.C., 600 Atlantic Avenue, Boston, MA, 02210-2206, US

(73) Assignee: Microsoft Corporation, Redmond, WA (US)

(21) Appl. No.: 10/987,128

(22) Filed: Nov. 12, 2004

(51) Int. Cl. G06F 9/46

(52) U.S. Cl. 705/8

(57) ABSTRACT

One embodiment of the invention is directed to automatically extending a task in a project schedule. If certain information items associated with a task are not specified, the scheduled completion time for a task may be automatically extended under the assumption that if these information items are unknown, the task will take longer to complete than originally planned. The project schedule, incorporating the automatically extended tasks, may then be displayed.

### FIELD OF THE INVENTION

The present invention relates to project management.

### DESCRIPTION OF THE RELATED ART

Development of large-scale, multi-component systems may be highly complex and may require a high degree of project management. Thus, project management tools, such as software programs, are often employed to aid in project management. Such tools may be used, for example, to define project tasks and create schedules for completion of these tasks. Some project management software tools allow project schedules to be created, displayed, and manipulated using a graphical user interface. For example, FIG. 1 shows a project schedule 100 that includes three tasks: task 101, task 103, and task 105. Each task is represented by a box and has a defined start and end date. The length of the box corresponds to the length of the task as specified by the start and end date of the task. In the example of FIG. 1, task 101 is scheduled to begin on Aug. 30, 2004 and end on Sep. 1, 2004, task 103 is scheduled to begin on Sep. 1, 2004 and end on Sep. 5, 2004, and task 105 is scheduled to begin on Sep. 5, 2004 and end on Sep. 8, 2004. A software project management tool may allow manipulation of project schedule 101, for example, by allowing the number of tasks, the order of tasks, and length of tasks to be redefined.

In many cases, project schedules, such as the project schedule shown in FIG. 1, are defined in the early stage of a project, before much is known about a task. That is, a project manager may estimate the time needed to complete a particular task without a good understanding of the amount of work the task entails, the end work product of the task, and/or the quality targets for the task. Thus, the time estimate may specify unrealistic deadlines, causing project developers to sacrifice quality in order to meet these deadlines.

### SUMMARY OF THE INVENTION

One illustrative embodiment of the invention is directed to a user interface comprising a graphical illustration of a quality metric of a project deliverable.

Another illustrative embodiment of the invention is directed to a method of graphically illustrating a project deliverable. The method comprises graphically illustrating a quality metric of the project deliverable.

A further illustrative embodiment is directed to a method of modifying a project schedule that includes at least one task, wherein the at least one task has a specified task length. The method comprises acts of: requesting at least one information item associated with the at least one task; when the at least one information item is not provided, automatically extending the specified task length to generate a modified task length for the at least one task; and displaying the project schedule, wherein the at least one task has the modified task length in the project schedule. Another illustrative embodiment is directed to at least one computer readable medium encoded with instructions that, when executed on a computer system, perform the above-described method.

Another illustrative embodiment is directed to a computer system that modifies a project schedule that includes at least one task, wherein the at least one task has a specified task length. The computer system comprises: a display; and at least one controller that requests at least one information item associated with the at least one task; when the at least one information item is not provided, automatically extends the specified task length to generate a modified task length for the at least one task; and displays the project schedule on the display, wherein the at least one task has the modified task length in the project schedule.

The summary provided above is intended to provide a basic understanding of the disclosure to the reader. This summary is not an exhaustive or limiting overview of the disclosure and does not define or limit the scope of the invention in any way. The invention is limited only as defined by the claims and the equivalents thereto.

### BRIEF DESCRIPTION OF THE DRAWINGS

FIG. 1 is an example of a project schedule which may be employed in embodiments of the invention;

FIG. 2 is a chart illustrating an example of a penalty logic algorithm, in accordance with one embodiment of the invention;

FIG. 3A is an example of a display of a project schedule that has not been automatically extended;

FIG. 3B is an example of a display of an automatically extended project schedule in accordance with one embodiment of the invention;

FIG. 4 is an example of a display of an automatically extended project schedule in accordance with another embodiment of the invention;

FIG. 5 is an example of a display of an automatically extended project schedule using a force field metaphor, in accordance with one embodiment of the invention;

FIG. 6 is an example of a display of an automatically extended project schedule using a fuzzy edge metaphor, in accordance with one embodiment of the invention;

FIG. 7 is a flow chart illustrating a process for automatically extending a project schedule, in accordance with one embodiment of the invention; and

FIG. 8 is an example of a display of an automatically extended project schedule using an error-bar metaphor, in accordance with one embodiment of the invention.

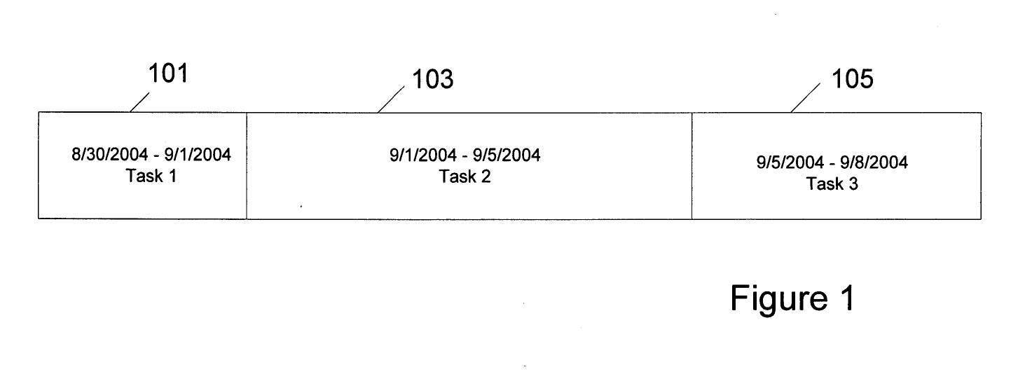

### DETAILED DESCRIPTION

One embodiment of the invention is directed to automatically modifying task lengths for tasks or project deliverables specified in a project schedule. As discussed above, an initial estimate of completion time for a task may be inaccurate due to lack of information about the task or other reasons, such as unanticipated problems or modification in scope of the task. Thus, in one embodiment of the invention, the initial estimate of the task length (i.e., the time allotted for completion of the task) may be automatically extended.

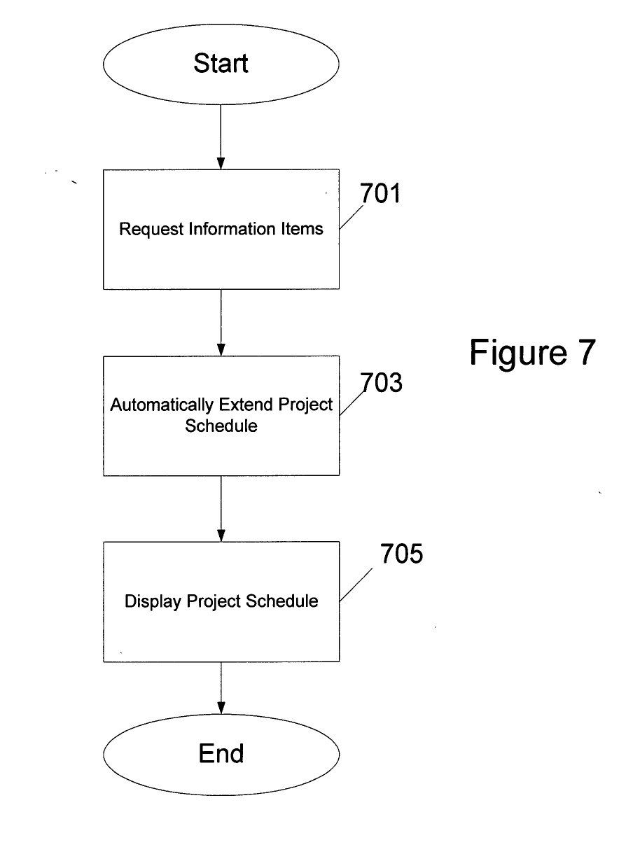

Automatically extending the time of completion of a task may be done in any suitable way. An example process for automatically extending the time of completion of a task is shown in FIG. 7. The process begins at act 701 wherein information items are requested. Thus, when a project schedule is created, one or more information items may be requested for a task in the project schedule. An information item for a task is any piece of information pertaining to the task. Examples of information items include, but are not limited to, information relating to the end work product of the task, information relating to quality targets for the task, information specifying who is the owner of the task, information pertaining to which developers are assigned to the task, information specifying inputs and outputs for the task, and/or any other suitable information item. Additionally, any information item that serves as a quality metric for the task may be used. It should be understood that any suitable information item may be used and the invention is not limited in this respect. If some or all of the information items requested for a task are not provided, the specified time of completion for the task may be automatically extended.

The information items for a task may be requested and/or provided in any suitable way and at any suitable time. For example, a project schedule may be defined using project management software. When a task is added to the project schedule, the project management software may request that the information items be provided. Alternatively, a user may provide the requested information items after the task has been defined, after the project schedule has been defined, or at any other suitable time. In one embodiment, the user creating the schedule need not provide each of the requested information items to the project management software tool, but may merely indicate whether all the requested information items are known or have been defined.

It should be appreciated that these are only a few examples of numerous ways in which the information items may be requested and/or provided and that any suitable way may be employed, as the invention is not limited in this respect. Additionally, this aspect of the invention is not limited to use with project management software tools, as associating information items with project tasks may be employed when creating project schedules without the use of a software tool.

The information items that are requested for a task may be indicated and associated with the task in any suitable way and the invention is not limited in this respect. For example, when using a software tool to create project schedules, the software tool may be programmed to request certain information items for each task, by default. Alternatively, a user may specify information items to be provided for a task. This user may be the same user that is creating the project schedule or a different user. Additionally, different tasks in the same project schedule may have different information items associated with them. Thus, a user creating a project schedule may be requested to provide a first set of information items for one task in the project schedule and may be requested to provide a second set of information items for a second task in the project schedule. In one embodiment, the two sets of information items may have some common information items associated with them, although the invention is not limited in this respect. Additionally, while the two sets of information items may request the same type of information items, the actual information items may differ. For example, two tasks in a project schedule may both include as an information item the name of the owner of the task, however the owner of the first task may be different from the owner of the second task.

It should be appreciated that these are only examples of way in which information items may be associated with a task and any suitable way may be employed, as the invention is not limited in this respect.

Referring to FIG. 7, after information items have been requested the process continues to act 703, wherein tasks in the project schedule are automatically extended. As discussed above, if some or all of the information items associated with a task are not provided, then the specified length of the task in the project schedule may be automatically extended by a certain length of time. This length of time may be determined in any suitable way.

For example, in one embodiment of the invention, penalty logic may be used. Penalty logic is an algorithm that may be used to determine the length of time to be added to a specified task length. Any suitable penalty logic algorithm may be used as the invention is not limited in this respect.

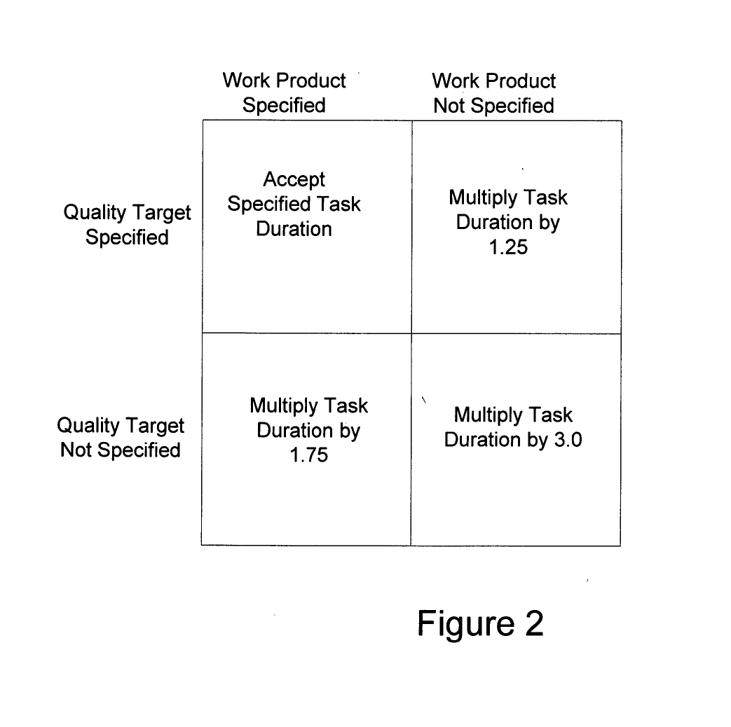

One example of a penalty logic algorithm that may be used is illustrated in FIG. 2. The illustrative penalty logic algorithm in FIG. 2 provides for two information items for a task. Specifically, each task should have at least one specified end work product and each task should have at least one defined quality target. That is, for a particular task, the end work product(s) should be specified so that the persons performing the task know what they are making and one or more quality targets should be specified so that the persons performing the task know when they are done and when they have completed a suitable work product. As shown in FIG. 2, if both the quality target(s) and work product(s) are specified for a task, then the specified task length may be accepted. If a work product is specified but no quality targets are specified, the specified task length may be increased by a factor of 1.25. If a quality target is specified but a work product is not specified, then the specified task length may be increased by a factor of 1.75. If neither a quality target nor a work product is specified, then the specified task length may be increased by a factor of 3.0.

It should be understood that in algorithm of FIG. 2, the factors by which a task length is multiplied when one or more information items are not specified are provided merely as examples. However, the invention is not limited in this respect, as any suitable factors may be used. Further, in the example of FIG. 2, only two information items were used in the penalty logic algorithm. However, the invention is not limited in this respect as any suitable number of information items may be used in a penalty logic algorithm and these information items are not limited to the information items used in the example of FIG. 2 (i.e., work product and quality targets).

It should further be understood that the penalty logic algorithm shown in FIG. 2 is provided merely as an example, as any suitable penalty logic algorithm may be used.

For example, a penalty logic algorithm may increase the specified length of a task by a certain percentage (e.g., five percent) for every requested information item that is not provided for a task. As another example, when an information item is not specified for a task, the length of downstream tasks may be affected. A task is considered to be downstream from another task if the task begins at a later time than the other task. Thus, for example, if an information item is not specified for a task, then the penalty logic may extend the specified length of every task downstream from the task by a certain percentage (e.g., five percent).

In the example penalty logic algorithms described above, task lengths are increased by fixed percentage or multiplied by a fixed factor when one or more information items are not specified. However, the invention is not limited in this respect, as weighted factors may be used to automatically extend task lengths. Thus, for example, the percentage by which a specified task length is extended when one or more information items are not specified may depend on the specified task length. Thus, the greater the task length, the greater the factor by which the task length is automatically extended. Any suitable method of weighting may be used. For example, a linear weighting may be used, such that the factor used to extend the task length increases linearly with the specified task length, or an exponential weighting may be used, wherein the factor used to extend the task length increases exponentially with the specified task length.

In the examples above, factors are weighted based on the length of the task, however the invention is not limited in this respect, as factors may be weighted based on any suitable criteria or criterion. For example, factors may be weighted based on how far downstream one task is from another task. Thus, for example, the penalty logic algorithm may increase the task lengths of every task downstream from a task with an unspecified information item. The factor by which the specified length of a downstream task is increased may be weighted based on how far downstream the task is from the task under evaluation. Thus, for example, it may be determined that a task further downstream is affected more or less than a task that is closer in the project schedule to the task under evaluation and the factor by which to increase the specified length of the task may be weighted accordingly. Any other suitable criterion or criteria may also be used to weight factors, as the invention is not limited in this respect.

Indeed, it should be appreciated from the above that any suitable penalty logic algorithm may be used, and the invention is not limited to any particular penalty logic algorithm.

Referring to FIG. 7, after the project schedule has been automatically extended, the process continues to act 705, wherein the project schedule may be displayed. Thus, for example, after the adjusted task lengths have been determined for the tasks in the project schedule, the visual display of the project schedule may be provided to illustrate that the task lengths have been adjusted. This may be done in any suitable way.

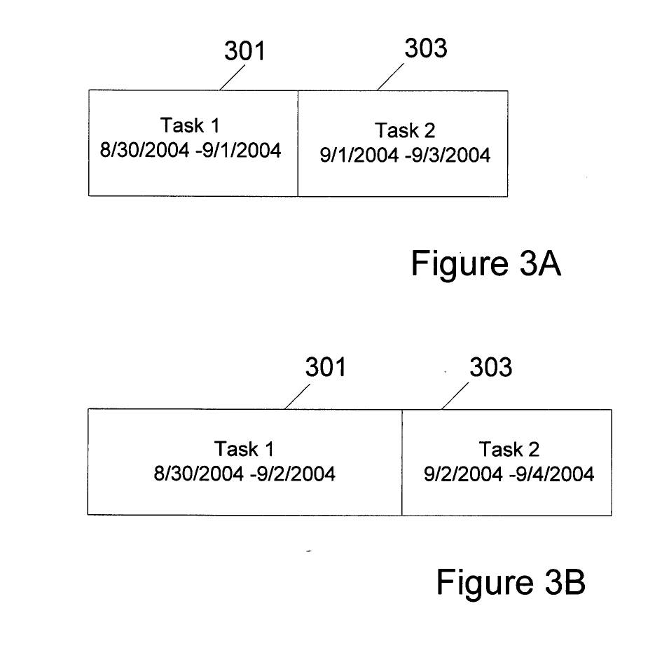

For example, in one embodiment, the task length as displayed in the project schedule may simply be extended. In FIG. 3A, a display of a project schedule before penalty logic is applied. The project schedule includes a task 301 which is scheduled to begin on Aug. 30, 2004 and end on Sep. 1, 2004 and task 301 which is scheduled to begin on Sep. 1, 2004 and end on Sep. 3, 2004. After penalty logic is applied, it is determined that task 301 should be extended by one day. Thus, as shown in FIG. 3B, a project schedule may be displayed that incorporates the automatic extension of task 301 based on penalty logic. In FIG. 3B, task 301 is automatically extended based on the penalty logic. Thus, the bar representing task 301 is extended and the task is shown as beginning on Aug. 30, 2004 and ending on Sep. 2, 2004.

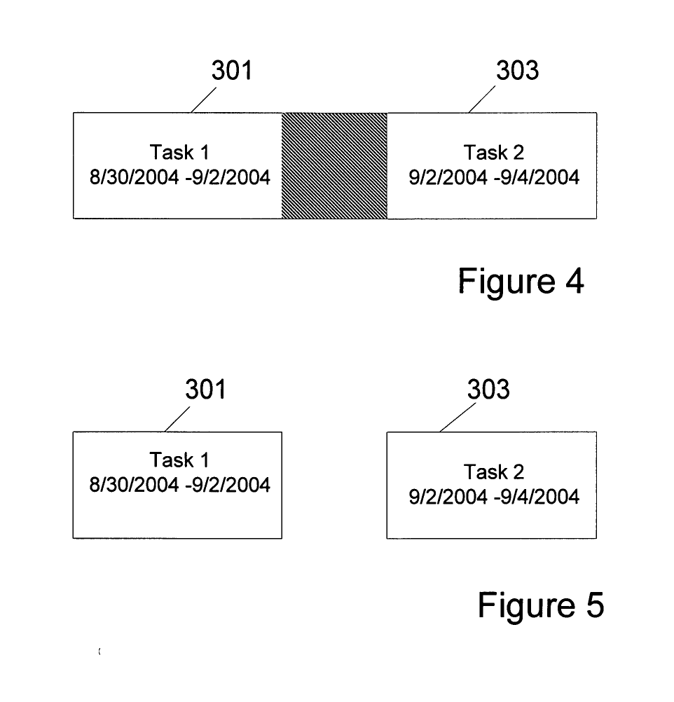

In another embodiment, when a task is automatically extended based on penalty logic, the portion of the task length that has been automatically added may be shaded. For example, as shown in FIG. 4, when task 301 is extended by one day, a portion of the bar representing task 301 may be shaded in the project schedule. The shaded portion represents the difference between the task length as originally indicated and the task length after penalty logic has been applied. Thus, in the example of FIG. 4, the portion of task 301 that is scheduled to occur from Sep. 1, 2004 to Sep. 2, 2004 is shaded.

In another embodiment, when a task is automatically extended based on penalty logic, the task may not be joined with subsequent tasks in the display schedule. That is, for example, a task that has been automatically extended may repel a subsequent task in the display of the project schedule. This method of displaying a task may be termed as a force-field metaphor. Thus, for example, as shown in FIG. 5, although task 301 has been automatically extended, the bar representing task 301 remains the same size. However, task 303 may not be joined to task 301. Instead, the start date of task 303 is scheduled to account for the penalty logic applied to task 301 and blank space is left in the display of the project schedule in between task 301 and task 303 to illustrate the automatic extension of task 301 based on the penalty logic.

In another embodiment, when a task is automatically extended based on penalty logic, the task may be displayed in the project schedule as having an error bar that indicates the magnitude of the penalty calculated using the penalty logic. This may be termed as an error bar metaphor. For example, as shown in FIG. 8, the task 301 is extended by an error bar 801 indicating the additional length of time added to the task length, as calculated using penalty logic. Thus, task 303 may not begin until the end of the error bar 303 in the display of the project schedule.

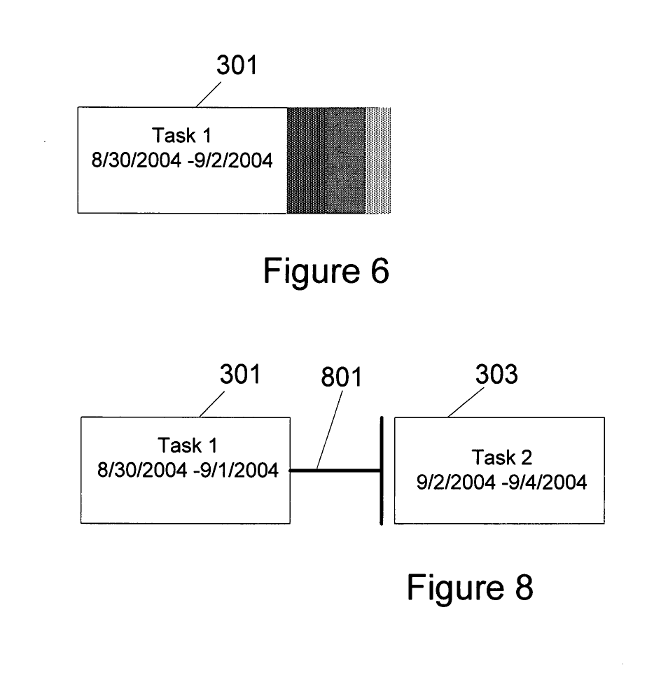

In another embodiment, when a task is automatically extended based on penalty logic, the task may be displayed in the project schedule as having a fuzzy edge. This may be termed as a fuzzy-edge metaphor. As shown in FIG. 6, the fuzzy edge of the task displayed in the project schedule indicates that the task has been automatically extended.

It should be appreciated that the above described manners in which a project schedule incorporating penalty logic may be displayed are provided only examples. Indeed, the project schedule may be displayed in any suitable way, as the invention is not limited in this respect.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware, or with general purpose hardware (e.g., one or more processors) that is programmed using microcode or software to perform the functions recited above.

In this respect, it should be appreciated that one implementation of the embodiments of the present invention comprises at least one computer-readable medium (e.g., a computer memory, a floppy disk, a compact disk, a tape, etc.) encoded with a computer program (i.e., a plurality of instructions), which, when executed on a processor, performs the above-discussed functions of the embodiments of the present invention. The computer-readable medium can be transportable such that the program stored thereon can be loaded onto any computer environment resource to implement the aspects of the present invention discussed herein. In addition, it should be appreciated that the reference to a computer program which, when executed, performs the above-discussed functions, is not limited to an application program running on a host computer. Rather, the term computer program is used herein in a generic sense to reference any type of computer code (e.g., software or microcode) that can be employed to program a processor to implement the above-discussed aspects of the present invention.

It should be appreciated that in accordance with several embodiments of the present invention wherein processes are implemented in a computer readable medium, the computer implemented processes may, during the course of their execution, receive input manually (e.g., from a user).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting. The invention is limited only as defined by the following claims and the equivalents thereto.

What is claimed is:

1. A user interface comprising:
a graphical illustration of a quality metric of a project deliverable.

2. The user interface of claim 1, wherein the quality metric affects a deliverable date of the project deliverable.

3. A method of graphically illustrating a project deliverable comprising:
graphically illustrating a quality metric of the project deliverable.

4. The method of claim 1, wherein the quality metric affects the deliverable date of the project deliverable.

5. A method of modifying a project schedule that includes at least one task, wherein the at least one task has a specified task length, the method comprising acts of:
requesting at least one information item associated with the at least one task;
when the at least one information item is not provided, automatically extending the specified task length to generate a modified task length for the at least one task; and
displaying the project schedule, wherein the at least one task has the modified task length in the project schedule.

6. The method of claim 5, wherein the act of automatically extending the specified task length further comprises an act of:
applying a penalty logic algorithm to determine the modified task length for the at least one task.

7. The method of claim 6, wherein the penalty logic algorithm increases the specified task length using a factor that is based on a number of information items that are not provided.

8. The method of claim 7, wherein the factor is weighted based on the specified task length.

9. The method of claim 5, wherein the at least one information item includes a work product for the at least one task.

10. The method of claim 5, wherein the at least one information item includes a quality target for the at least one task.

11. At least one computer-readable medium encoded with instructions that, when executed on a computer system perform a method of modifying a project schedule that includes at least one task, wherein the at least one task has a specified task length, and wherein the method comprises acts of:
requesting at least one information item associated with the at least one task;
when the at least one information item is not provided, automatically extending the specified task length to generate a modified task length for the at least one task; and
displaying the project schedule, wherein the at least one task has the modified task length in the project schedule.

12. The at least one computer-readable medium of claim 11, wherein the act of automatically extending the specified task length further comprises an act of:
applying a penalty logic algorithm to determine the modified task length for the at least one task.

13. The at least one computer-readable medium of claim 12, wherein the penalty logic algorithm increases the specified task length using a factor that is based on a number of information items that are not provided.

14. The at least one computer-readable medium of claim 13, wherein the factor is weighted based on the specified task length.

15. The at least one computer-readable medium of claim 11, wherein the at least one information item includes a work product for the at least one task.

16. The at least one computer-readable medium of claim 11, wherein the at least one information item includes a quality target for the at least one task.

17. A computer system that modifies a project schedule that includes at least one task, wherein the at least one task has a specified task length, the computer system comprising:
a display; and
at least one controller that:
requests at least one information item associated with the at least one task;
when the at least one information item is not provided, automatically extends the specified task length to generate a modified task length for the at least one task; and
displays the project schedule on the display, wherein the at least one task has the modified task length in the project schedule.

18. The computer system of claim 17, wherein the at least one controller applies a penalty logic algorithm to determine the modified task length for the at least one task.

19. The computer system of claim 18, wherein the penalty logic algorithm increases the specified task length using a factor that is based on a number of information items that are not provided.

20. The computer system of claim 19, wherein the factor is weighted based on the specified task length.

21. The computer system of claim 17, wherein the at least one information item includes a work product for the at least one task.

22. The computer system of claim 17, wherein the at least one information item includes a quality target for the at least one task.
